(19) United States
(12) Patent Application Publication
(10) Pub. No.: US 2006/0001712 A1
(43) Pub. Date: Jan. 5, 2006

(54) Ink cartridge having projections formed on outer surface of its casing

(75) Inventor: Toyonori Sasaki, Anjo-shi (JP)

Correspondence Address: BANNER & WITCOFF, LTD.;Counsel for Brother Industries, 1001 G STREET, N.W., 11TH FLOOR, WASHINGTON, DC, 20001-4597, US

(73) Assignee: Brother Kogyo Kabushiki Kaisha, Nagoya-shi (JP)

(21) Appl. No.: 11/169,679

(22) Filed: Jun. 30, 2005

(30) Foreign Application Priority Data
Jun. 30, 2004 (JP) 2004-192628

(51) Int. Cl. B41J 2/175

(52) U.S. Cl. 347/86

(57) ABSTRACT

An ink cartridge including: a casing having an ink chamber for storing the ink; and a plurality of projections projecting from an outer surface of the casing and spaced apart from each other. The plurality of projections preferably includes at least three projections which are arranged at substantially the same pitch. Each of the plurality of projections is preferably provided by a projecting plate which is elongated along the outer surface of the casing. A height of each of the plurality of projections is preferably is larger than a pitch between each adjacent pair of the plurality of projections. The plurality of projections are preferably formed integrally with the casing.

This application is based on Japanese Patent Application No. 2004-192628 filed on Jun. 30, 2004, the content of which is incorporated hereinto by reference.

### BACKGROUND OF THE INVENTION

1. Field of the Invention

The present invention relates to an ink cartridge having a configuration effective to protect its casing from an impact applied thereto.

2. Discussion of Related Art

There is known an ink cartridge, as disclosed in U.S. Pat. No. 6,786,581 (corresponding to JP-2001-113723A), which is to be installed on an inkjet recording apparatus, so that an ink contained in the cartridge is consumed in a recording operation performed by the recording apparatus. The ink cartridge, which is commonly made of a resin material is breakable, for example, when it is carelessly dropped onto a floor or hit against an object after being taken out a package, namely, before or upon its installation on the recording apparatus. Where a resin-made casing of the ink cartridge is cracked or broken, an ink stored in the casing is likely to leak, getting the surrounding dirty with the ink leaking out of the casing and even causing the ink cartridge to be unserviceable.

### SUMMARY OF THE INVENTION

The present invention was made in view of the background prior art discussed above. It is therefore an object of the invention to provide an ink cartridge capable of protecting its casing from an impact applied thereto, This object may be achieved according to a principle of the invention, which provides an ink cartridge including: a casing having an ink chamber for storing the ink; and a plurality of projections projecting from an outer surface of the casing and spaced apart from each other. The plurality of projections preferably includes at least three projections which are arranged at substantially the same pitch. Each of the plurality of projections is preferably provided by a projecting plate which is elongated along the outer surface of the casing. A height of each of the plurality of projections is preferably is larger than a pitch between each adjacent pair of the plurality of projections. The plurality of projections are preferably formed integrally with the casing.

In this ink cartridge constructed according to the invention, the plurality of projections are formed on the outer surface of the casing and are spaced apart from each other. The provision of the projections on the outer surface of the casing is effective to protect the casing from an impact applied thereto, for example, when the ink cartridge is carelessly dropped onto a floor or hit against an object. Thus, the casing of the ink cartridge is advantageously prevented from being broken or damaged, thereby avoiding the ink from leaking out of the ink chamber and failure of the ink cartridge serving as an ink supplier.

### BRIEF DESCRIPTION OF THE DRAWINGS

The above and other objects, features, advantages and technical and industrial significance of the present invention will be better understood by reading the following detailed description of presently preferred embodiment of the invention, when considered in connection with the accompanying drawings, in which:

FIG. 1 is a view schematically showing an inkjet recording apparatus equipped with an ink cartridge which is constructed according to an embodiment of the invention;

FIG. 2A is an elevational view in vertical cross section of the ink cartridge;

FIG. 2B is a cross sectional view taken along line 2B-2B of FIG. 2A; and

FIG. 3 is a perspective view of the ink cartridge.

### DETAILED DESCRIPTION OF THE PREFERRED EMBODIMENT

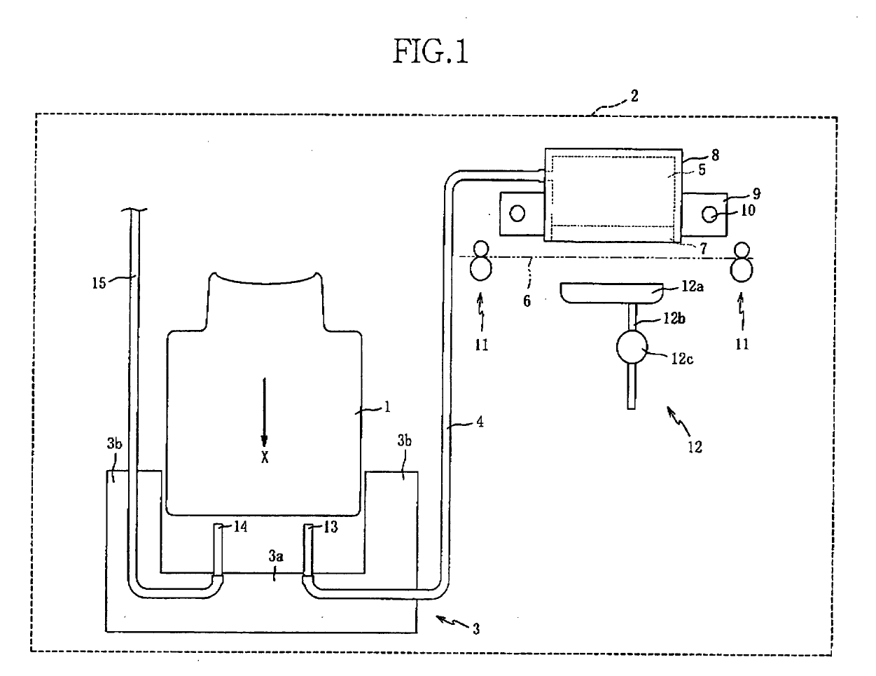

There will be described an ink cartridge 1 constructed according to an embodiment of the invention, by reference to FIGS. 1-3.

The ink cartridge 1 is to be installed on an inkjet recording apparatus in the form of an inkjet printer 2, which is schematically shown in FIG. 1, including: a mount portion 3 on which the ink cartridge 1 is removably mounted; a buffer tank 5 for storing the ink supplied from the ink cartridge 1 through an ink supplying tube 4; a recording head 7 for ejecting the ink stored in the buffer tank 5, toward a paper sheet 6 as a recording medium; a carriage 9 for carrying a recording head unit 8 equipped with the buffer tank 5 and the recording head 7; a pair of guide shafts 10 for guiding the carriage 9 which is movable along a straight line; a feeding device 11 for feeding the paper sheet 6 in a predetermined direction; and a purging device 12. It is noted that although only the single ink cartridge 1 is illustrated in FIG. 1, a plurality of ink cartridges 1 are installed on the inkjet printer 2 in the present embodiment, so that a full-color printing operation is performed with four color inks (e.g., cyan, magenta, yellow and black inks) which are stored in the respective ink cartridges 1.

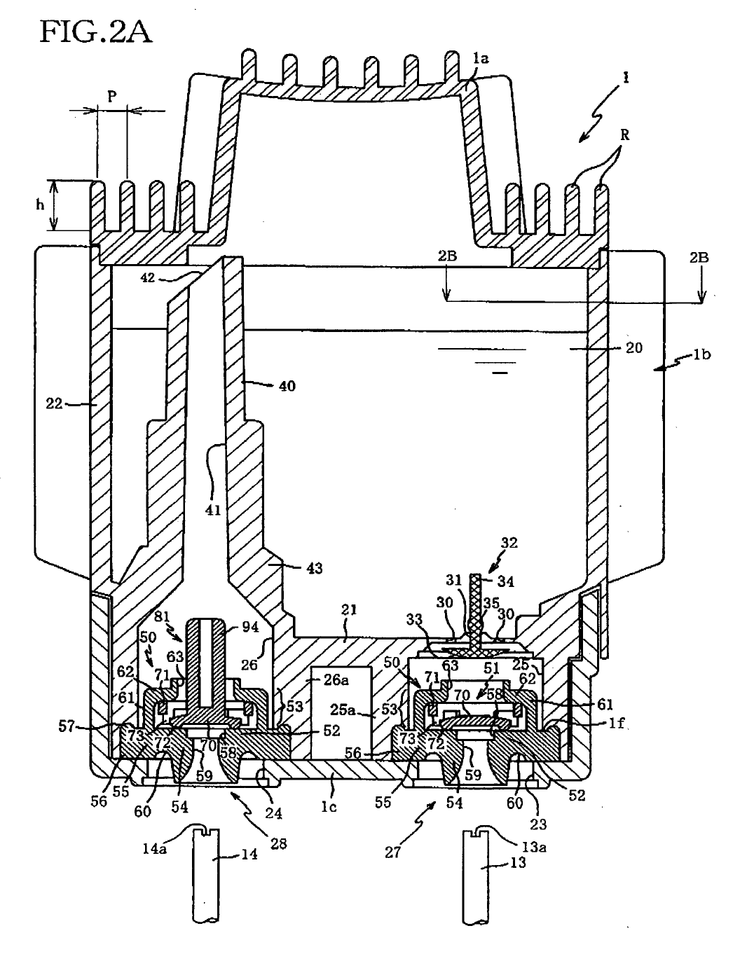

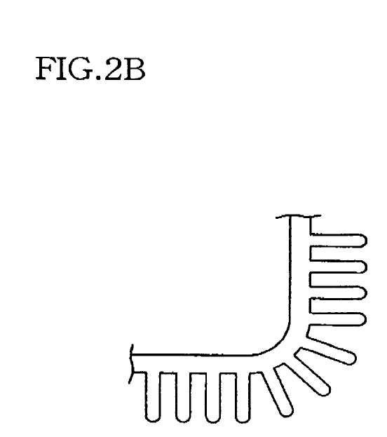

The mount portion 3 has a base portion 3a and a pair of guide portions 3b which extend from respective opposite end portions of the base portion 3a. An ink supplying pipe 13 and an air introducing pipe 14 are provided to project from the base portion 3a, so that the ink stored in the ink cartridge 1 can be supplied to an exterior of the ink cartridge 1 through the ink supplying pipe 13 while an atmospheric air can be introduced into the ink cartridge 1 through the air introducing pipe 14. Each of the pipes 13, 14 has an upper distal end that is made substantially flat. A cutout 13a, 14a (see FIG. 2A) is formed in the upper distal end of the pipe 13, 14, so that inside and outside of the pipe 13, 14 are communicable with each other through the cutout 13a, 14a when the pipe 13, 14 is held in contact with a valve member that is described below.

The ink supplying pipe 13 is connected at its lower end to the ink supplying tube 4, so as to be held in communication with the buffer tank 5 via the ink supplying tube 4. The air introducing pipe 14 is connected at its lower end portion to an air introducing tube 15, so as to be held in communication with an atmosphere via the air introducing tube 15.

The recording head 7 is constituted principally by a cavity unit (not shown) and a piezoelectric actuator plate (not shown) which is bonded to an upper surface of the cavity unit. The cavity unit is a laminar structure consisting of a plurality of plates which cooperate with one another to define a plurality of cavities for accommodating the ink supplied from the buffer tank 5. The piezoelectric actuator plate has a plurality of active portions corresponding to the respective cavities of the cavity unit. The active portions of the piezoelectric actuator plate are selectively deformable upon application of a drive voltage thereto, which is controlled by CPU (not shown), so as to eject the ink from the corresponding cavities through nozzles (not shown). It is noted that the nozzles are formed through a nozzle-defining surface of the cavity unit of the recording head 7, which surface is to be opposed to the paper sheet 6. The nozzles are arranged in a plurality of rows, such that the nozzles of each adjacent pair of the rows are positioned in a zigzag pattern.

The purging device 12 is disposed in a purging operation position located outside a printing area (within which the recording head 7 is moved for achieving the printing operation), and is opposed to the recording head 7 when the recording head 7 is positioned in the purging operation position. The purging device 12 has a purge cap 12a, a waste ink tube 12b and a pump 12c. The purge cap 12a is provided to cover the nozzle-defining surface of the recording head 7. The pump 12c is activated to suck poor-quality or waste ink from the nozzles through the waste ink tube 12b which is held in communication with the purge cap 12a.

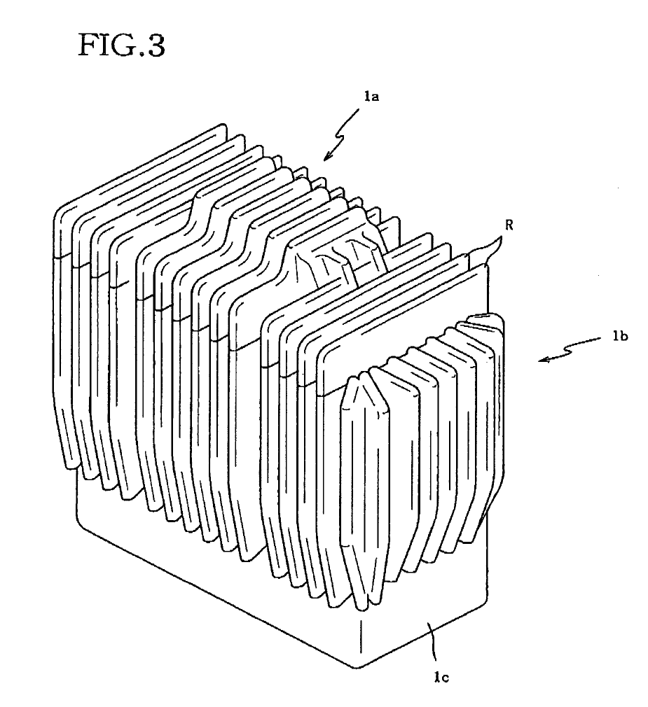

Referring next to FIGS. 2A, 2B and 3, there will be described a construction of the ink cartridge 1 in detail. FIG. 2A is an elevational cross sectional view of the ink cartridge 1. FIG. 2B is a cross sectional view taken along line 2B-2B of FIG. 2A and showing a corner of a circumferential side wall of the cartridge 1. FIG. 3 is a perspective view of the cartridge 1.

The ink cartridge 1 is constituted by a casing 1a, 1b, 1c having an ink chamber 20 for storing the ink. The casing 1a, 1b, 1c includes an ink-chamber definer body 1a, 1b defining the ink chamber 20 therein. The ink-chamber definer body 1a, 1b includes a lid member 1a and a vessel member 1b which are connected to each other. The vessel member 1b has a bottom wall 21, a circumferential side wall 22 and an upper opening which is surrounded by the circumferential side wall 22 and which is closed by the lid member 1a. The casing further 1a, 1b, 1c includes a cover member 1c which covers a communication-passage defining wall (which is described below) of the ink-chamber definer body 1a, 1b so as to provide a bottom wall of the casing 1a, 1b, 1c. The cover member 1c has a pair of communication holes 23, 24 formed therethrough, such that the ink chamber 20 is communicable with an exterior of the casing 1a, 1b, 1c through the communication holes 23, 24. The ink cartridge 1 is assembled by fusing or otherwise bonding the lid member 1a and the cover member 1c to the vessel member 1b. Each of the lid member 1a, vessel member 1b and cover member Ic is made of a resin material such as polypropylene, polystyrene and polyacetal.

In the ink cartridge 1, a plurality of projections are provided to project from an outer surface of the casing 1a, 1b, 1c. In the present embodiment, each of the plurality of projections is provided by a fin or rib R (i.e., projecting plate) which is elongated along the outer surface of the casing 1a, 1b, 1c The plurality of ribs R are spaced apart from each other, and extend outwardly from the lid member 1a (which constitutes a top wall of the casing 1a, 1b, ic) and the circumferential side wall 22 of the vessel member 1b (which constitutes a circumferential side wall of the casing 1a, 1b, 1c). The plurality of ribs R are formed integrally with the lid member 1a and the circumferential wall 22 which have inside surfaces facing the ink chamber 20. Each of the ribs R projects from the outer surface of a corresponding portion of the casing 1a, 1b, 1c by a predetermined distance or height h which is larger than a pitch P between each adjacent pair of the ribs R. The height h is preferably about 5 mm, while the pitch p is preferably 3-4 mm. In the present embodiment, the number of the ribs R formed on the lid member 1a and extending in a widthwise direction of the lid member 1a (i.e, in a direction perpendicular to the drawing sheet of FIG. 2A) is fourteen, while the number of the ribs R formed on the circumferential side wall 22 of the vessel member 1b and extending in a vertical direction of the casing 1a, 1b, 1c (i.e., in a vertical direction in the drawing sheet of FIG. 2A) is forty-six.

The provision of the ribs R on the outer surface of the casing 1a, 1b, 1c is effective, when the ink cartridge 1 is carelessly dropped onto a floor or hit against an object, to avoid the casing 1a, 1b, 1c from being broken by an impact exerted thereto from the floor or object. It is therefore possible to prevent the floor or surrounding area from being stained with the ink having leaked through a broken portion of the casing 1a, 1b, 1c of the cartridge 1. The ribs R are elastically deformable upon application of an impact thereto, so as to alleviate the impact acting on the casing 1a, 1b, 1c, advantageously avoiding damage of the casing 1a, 1b, 1c. It is noted that the ribs R are not formed on the cover member 1c which covers the communication-passage defining wall of the vessel member 1b, since the ink chamber 20 is not likely to be broken where the impact is applied to the cover member 1c which cooperates with the communication-passage defining wall of the vessel member 1b to constitutes a double-wall structure protecting the ink chamber 20 from the exterior of the casing 1a, 1b, 1c of the ink cartridge 1.

The vessel member 1b has an ink supplying port 25 and an air introducing port 26 formed in its bottom wall 21, such that the ink stored in the ink chamber 20 can be supplied to the exterior of the ink cartridge 1 through the ink supplying port 25, and such that the air can be introduced into the ink chamber 20 through the air introducing port 26. The vessel member 1b includes integrally-formed first and second tubular walls 25a, 26 projecting downwardly from its bottom wall 21. The ink supplying port 25 and the air introducing port 26 are defined in or surrounded by the first and second tubular walls 25a, 26a, respectively. When the ink cartridge 1 is mounted on the mount portion 3 of the inkjet printer 2, the ink supplying pipe 13 and the air introducing pipe 14 are introduced into the ink supplying port 25 and the air introducing port 26, respectively.

The ink cartridge 1 further has first and second seals 27, 28 which are received in the ink supplying port 26 and the air introducing port 26, respectively. The seals 27, 28 seal the supplying port 25 and the air introducing port 26, respectively, while the ink cartridge 1 is not mounted on the mount portion 3.

Further, in the bottom wall 21 of the vessel member 1b, there are formed a plurality of communication holes 30 through which the ink chamber 20 and the ink supplying port 25 are communicable with each other. The communication holes 30 are selectively opened and closed by an inverted umbrella-shaped valve member 32 which is made of a synthetic resin having a certain degree of elasticity.

The valve member 32 includes a disk-shaped head portion 33 and a stem portion 34 which formed integrally with each other. The head portion 33 is opposed to lower ends of the respective communication holes 30, and is held by the stem portion 34 which extends from substantially the center of the head portion 33 and which is slidably received in a through-hole 31 formed through the bottom wall 21. The through-hole 31 is located at a center of a circle on which the communication holes 30 lie. The stem portion 34 has, in its axially intermediate portion, an annular protrusion 35 whose diameter is larger than that of the through-hole 31, so that the valve member 32 is vertically movable relative to the bottom wall 21 between opposite ends which are defined by the disk-shaped head portion 33 and the annular protrusion 35 of the stem portion 84. Owing to its own weight, the valve member 32 is normally held in its open position in which the head portion 33 is spaced apart from the communication holes 30 while the annular protrusion 35 of the stem portion 34 is held in contact with the upper surface of the bottom wall 21, whereby the ink is allowed to flow in a direction away from the ink chamber 20 toward the ink supplying port 25. However, when there is caused a flow of the ink in the opposite direction, the valve member 32 is placed in its closed position in which the head portion 33 is moved upwardly to close the communication holes 30, thereby inhibiting the flow of the ink in the opposite direction. That is, the valve member 32 serves as a check valve.

The vessel member 1b further includes an integrally-formed air guiding tubular wall 40 extends upwardly from the bottom wall 21 toward the lid member 1a which closes the upper opening of the vessel member 1b. The air guiding tubular wall 40 has an upper opening end 42 which is located above a level of the ink stored in the ink chamber 20, so that the atmospheric air introduced through the air introducing pipe 14 is delivered along a guide passage 41 defined in the air guiding tubular wall 40 to an upper region of the ink chamber 20. The guide passage 41 of the air guiding tubular wall 40 is held in communication with the air introducing port 26 via a connection passage defined in a tapered inner surface of a connection portion 43 (which is provided by a proximal end portion of the tubular wall 40).

The first seal 27 disposed in the ink supplying port 25 is constituted by an elastically-deformable holding member 50 which is provided by a single piece made of a rubber or other elastic material, and a valve member 51 which is made of a synthetic resin. The holding member 50 has a generally tubular shape, and includes a valve seat portion 52, a biasing portion (biaser) 58, a tubular portion 64 and an outer circumferential wall portion 55. The valve seat portion 52 is provided by its axially intermediate portion. The biasing portion 53 is located on one of axially opposite sides of the valve seat portion 52 that is closer to the ink chamber 20 than the other of the axially opposite sides of the valve seat portion 52. The tubular portion 54 is located on the other of the axially opposite sides of the valve seat portion 52. The outer circumferential wall portion 55 surrounds the tubular portion 54, such that the outer circumferential wall portion 55 is radially spaced apart the tubular portion 64 by a predetermined distance, and such that an outer circumferential surface of the tubular portion 54 and an inner circumferential surface of the outer circumferential wall portion 56 are circumferentially extend in parallel with each other. The valve member 51 is held in the holding member 50, while being biased by the biasing portion 53 in a biased direction that causes the valve member 51 to be seated on the valve seat potion 52 so as to be placed in its closed position.

The outer circumferential wall portion 55 has, in one of axially opposite end portions that is remote from the biasing portion 53, a large-diameter portion 56 which projects outwardly in the radial direction, so that the biasing portion 53 and the other portion of the outer circumferential wall portion 55 have a diameter smaller than a diameter of the large-diameter portion 56. The ink supplying port 25 has a small-diameter region and a large-diameter region which is located on one of axially opposite sides of the small-diameter region that is remote from the ink chamber 20. The biasing portion 63 of the holding member 50 is accommodated in the small-diameter region of the ink supplying port 25, while the large-diameter portion 56 of the holding member 50 is accommodated in the large-diameter region of the ink supplying port 25. In the process of assembling the ink cartridge 1, the vessel member 1b and the cover member 1c are bonded to each other, while the holding member 50 is gripped at its large-diameter portion 56 between the cover member 1c and a shoulder surface if which is located between the small-diameter region and the large-diameter region of the ink supplying port 26, for thereby preventing an ink leakage between the vessel member 1b and the first seal 27.

The valve seat portion 52 and the tubular portion 54 of the holding member 50 have a through-hole 58 and a pipe receiver hole 59 which are both located at an axis of the holding member 60 and which are contiguous to each other. When the ink cartridge 1 is mounted on the mount portion 8, the ink supplying pipe 18 is fluid-tightly fitted into the pipe receiver hole 59 of the tubular portion 54. For assuring such a fluid-tight fitting, the pipe receiver hole 59 has an inside diameter smaller than an outside diameter of the ink supplying pipe 13. Further, the through-hole 58 has an inside diameter which is larger than the inside diameter of the pipe receiver hole 59 and which is larger than the outside diameter of the ink supplying pipe 13. It is noted that the pipe receiver hole 59 has, in its axially outside portion, a tapered portion whose diameter is increased as viewed in an axially outward direction of the hole 59.

The outer circumferential wall portion 55 is radially spaced apart from the tubular portion 54 by an annular groove 60, so that the tubular portion 54 is elastically deformable or displaceable, relative to the outer circumferential wall portion 55, on a plane perpendicular to an axis of the pipe receiver hole 59. The biasing portion 53 includes a side wall portion 61 which extends from a periphery of the valve seat portion 62 in a direction toward the ink chamber 20, and an upper wall portion 62 which extends from the side wall portion 61 in a radially inward direction so as to be in contact with one of axially opposite end surfaces of the valve member 51 that is remote from the valve seat portion 52. The upper wall portion 62 extends radially inwardly from the side wall portion 61 over a predetermined distance, so as to define an opening 63 which is surrounded by the upper wall portion 62. Owing to an elasticity of the material forming the holding member 50, the biasing portion 53 of the holding member 50 biases the valve member 51 in the biased direction that causes the valve member 51 to be seated on the valve seat portion 52. Thus, the valve member 51 is normally held in close contact with the valve seat portion 52, namely, normally placed in its closed position. However, when the ink cartridge 1 is mounted on the mount portion 3, the ink supplying pipe 13 is introduced into the pipe receiver hole 59 and the through-hole 68, and then forces the valve member 51 upwardly, i.e., toward the ink chamber 20. With the valve member 51 being thus forced upwardly, the side wall portion 61 and the upper wall portion 62 of the biasing portion 53 of the holding member 50 are expanded and inclined, respectively, thereby allowing the valve member 51 to be moved upwardly. The upward movement of the valve member 51 causes formation of a spacing gap between the valve member 51 and the valve seat portion 52, thereby allowing flow of the ink through the spacing gap.

The valve member 51 includes a bottom portion 70 which is to be in contact with the valve seat portion 52 of the holding member 50, and an outer circumferential wall portion 71 which extends from a periphery of the bottom portion 70 in an upward direction (i.e., direction toward the ink chamber 20). The bottom portion 70 has, in its surface that is to be opposed to the valve seat portion 52 of the holding member 50, an annular protrusion 72 which is located on a radially inner side of the outer circumferential wall portion 71 and on a radially outer side of the through-hole 58 of the holding member 50. With the valve member 51 being accommodated in the holding member 50, the circumferential wall portion 71 of the valve member 70 is held in close contact with a lower surface of the upper wall portion 62 of the biasing portion 53 of the holding member 50, and is forced downwardly. Since the valve member 51 is thus forced downwardly, the valve seat portion 52 of the holding member 50 is elastically deformed by the annular protrusion 72 which is held in close contact with the valve seat portion 52.

The valve member 51 has a plurality of communication apertures 73 which are formed through the bottom portion 70 and which are located between the annular protrusion 72 and the outer circumferential wall portion 71 as viewed in a radial direction of the valve member 51. The plurality of communication apertures 73 are positioned to be spaced apart from each other as viewed in a circumferential direction of the valve member 51.

The second seal 28 disposed in the air introducing port 26 is constituted by the elastically-deformable holding member 50 and a valve member 81, which is substantially identical with the valve member 51 of the first seal 27 except for provision of a cylindrical portion 94 therein. That is, the valve member 81 has the above-described bottom portion 70, outer circumferential wall portion 71, annular protrusion 72 and communication apertures 73, as the valve member 51. The valve member 81 further has the cylindrical portion 94 which extends upwardly from substantially the center of an upper surface of the bottom portion 57. The cylindrical portion 94 of the valve member 81 extends through the opening 63 which is surrounded by the upper wall portion 62 of the holding member 50, with a spacing gap between an outer circumferential surface of the cylindrical portion 94 and an inner circumferential surface of the opening 63. It is noted that the same reference signs as used in the above description of the first seal 27 are used to identify the functionally corresponding or structurally similar elements.

For installing the ink cartridge 1 onto the inkjet printer 2, the cartridge 1 is moved toward the mount portion 3 in a direction indicated by arrow X (see FIG. 1) so as to be mounted onto the mount portion 3. In this instance, the ink supplying pipe 13 and the air introducing pipe 14 are introduced into the respective pipe receiver holes 59, increasing diameters of the respective tubular portions 54. The thus introduced pipes 13, 14 are brought into contact with the bottom portions 70 of the respective valve members 51, 81. With further movement of the cartridge 1 in the direction indicated by the arrow X, each of the valve members 51, 81 is moved toward the ink chamber 20, i.e., in a direction away from the valve seat portion 52, whereby the communication apertures 73 of the valve members 51, 81 are brought into communication with the cutouts 13a, 14a of the ink supplying pipe 13 and the air introducing pipe 14 through the spacing gaps between the valve members 51, 81 and the valve seat portions 52, thereby establishing an air introducing passage allowing the introduction of the air into the ink chamber 20 via the air introducing pipe 14, communication apertures 73 and air guiding tubular wall 40, and at the same time an ink supplying passage allowing the supply of the ink from the ink chamber 20 toward the recording head 7 via the communication holes 30, communication apertures 73 and ink supplying pipe 13.

In the present embodiment, the bottom wall 21 and the first and second tubular walls 25a, 26a of the vessel member 1b cooperate to constitute the above-described communication-passage defining wall through which first and second communication passages communicating between inside and outside of the ink chambers 20 are formed. The first communication passage is constituted by the above-described ink supplying port 25 and communication holes 30, while the second communication passage is constituted by the above-described air introducing port 26 and guide passage 41.

In the ink cartridge 1 constructed according to the present embodiment, the multiplicity of ribs R are substantially uniformly formed on the top wall and a majority of the circumferential side wall of the casing 1a, 1b, 1c, namely, on the lid member 1a and a majority of the side circumferential surface 22 of the vessel member 1b. When the ink cartridge 1 is carelessly dropped onto a floor or hit against an object, the ribs R formed on the outer surface of the casing 1a, 1b, 1c effectively absorb an impact applied thereto from the floor or object, thereby making it possible to prevent the casing 1a, 1b, 1c from being broken and accordingly avoid the floor or surrounding area from being stained with the ink leaking out of the casing 1a, 1b, 1c.

Further, in the ink cartridge 1, the ribs R are formed integrally with the casing 1a, 1b, 1c, namely, each of the ribs R and a portion of the casing 1a, 1b, 1c, from which the each of the ribs R extends, are provided by a single piece. Therefore, the ink cartridge 1 can be easily manufactured by using a smaller number of dies in an injection molding, than where the ribs R are formed independently of the casing 1a, 1b, 1c. Further, the formation of the ribs R integrally with the casing 1a, 1b, 1c leads to reduction in the number of pieces required to assemble the ink cartridge 1 and accordingly reduction in the manufacturing cost.

Further, in the ink cartridge 1, the projections are provided by the ribs R, i.e., projecting plates elongated along the outer surface of the casing 1a, 1b, 1c. Since each of the projections is thus given a simple shape, the ink cartridge 1 can be easily manufactured.

Further, in the ink cartridge 1, the height h by which each rib R projects from the outer surface of the casing 1a, 1b, 1c is adapted to be larger than the pitch P between each adjacent pair of the ribs R. This arrangement is effective to cause the ribs R to further effectively absorb an impact when the cartridge 1 is dropped or hit against an object, thereby further reliably protecting the casing 1a, 1b, 1c.

Further, in the ink cartridge 1, the ribs R are formed only on the outer surface of the lid member 1a and the majority of the outer surface of the vessel member 1b, namely, only on a portion of the ink-chamber definer body 1a, 1b which portion is distant from or uncovered with the cover member 1c. Since the ribs R are not formed on the cover member 1c and a covered portion of the vessel member 1b covered by the cover member 1c, it is possible to reduce a projection-formed area, thereby making it possible to easily manufacture the ink cartridge 1 and reduce the manufacturing cost.

Further, the ribs R serving as an impact absorber for absorbing the impact applied to the ink cartridge 1 may be considered to serve also as cooling fins for dissipating heat.

While the presently preferred embodiment of the invention has been described above in detail, it is to be understood that the invention is not limited to the details of the illustrated embodiment, but may be embodied with various other changes, modifications and improvements.

For example, in the above-described embodiment, each of the projections is provided by the projecting plate projecting from the outer surface of the casing 1a, 1b, 1c and elongated along the outer surface of the casing 1a, 1b, 1c. However, each of the projections may be provided by a conical projection projecting from the outer surface of the casing 1a, 1b, 1c.

Further, while the ribs R are formed integrally with the lid member 1a and the vessel member 1b in the above-described embodiment, the ribs R may be bonded to the lid member 1a and the vessel member 1b after being formed independently of the lid member 1a and the vessel member 1b.

What is claimed is:

1. An ink cartridge comprising:
a casing having an ink chamber for storing the ink; and
a plurality of projections projecting from an outer surface of said casing and spaced apart from each other.

2. The ink cartridge according to claim 1, wherein said plurality of projections includes at least three projections which are arranged at substantially the same pitch.

3. The ink cartridge according to claim 1, wherein each of said plurality of projections and a portion of said casing, from which said each of said plurality of projections extends, are provided by a single piece which is made of a resin material.

4. The ink cartridge according to claim 1, wherein each of said plurality of projections is provided by a projecting plate which is elongated along said outer surface of said casing.

5. The ink cartridge according to claim 1, wherein each of said plurality of projections projects from said outer surface of said casing by a height which is larger than a pitch between each adjacent pair of said plurality of projections.

6. The ink cartridge according to claim 1,
wherein said casing includes an ink-chamber definer body defining said ink chamber therein,
wherein said ink-chamber definer body has a communication passage formed through a communication-passage defining wall thereof, such that said communication passage communicates between inside and outside of said ink chamber,
and wherein said plurality of projections project at least from a portion of said ink-chamber definer body, which portion is distant from said communication-passage defining wall.

7. The ink cartridge according to claim 6, further comprising a seal which is received in said communication passage,
wherein said casing further includes a cover member which covers at least said communication-passage defining wall of said ink-chamber definer body so as to cooperate with said ink-chamber definer body to hold said seal,
and wherein said plurality of projections project at least from said portion of said ink-chamber definer body, which portion is uncovered by said cover member.

8. The ink cartridge according to claim 7,
wherein said seal includes a valve member which is operable to selectively open and close said communication passage, and a holding member which holds said valve member,
and wherein said holding member is held between said ink-chamber definer body and said cover member of said casing.

9. The inkjet cartridge according to claim 8, wherein said seal further includes a biaser which biases said valve member in a direction that causes said valve member to be placed in a closed position thereof closing said communication passage.

10. The inkjet cartridge according to claim 1,
wherein said casing has a communication hole opening in a bottom wall thereof, such that said ink chamber is communicable with an exterior of said casing through said communication hole,
wherein said casing has a top wall which is opposed to said bottom wall and a circumferential side wall which is connected at opposite ends thereof with said top and bottom walls,
and wherein said plurality of projections project at least from said top wall and a majority of said circumferential side wall.
